(19) United States
(12) Patent Application Publication
(10) Pub. No.: US 2009/0153299 A1
(43) Pub. Date: Jun. 18, 2009

(54) Wrapping with Antenna

(75) Inventor: David K. Ovard, Meridan, ID (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: Keystone Technology Solutions, LLC

(21) Appl. No.: 11/958,847

(22) Filed: Dec. 18, 2007

(51) Int. Cl. H04B 7/00

(52) U.S. Cl. 340/10.1

(57) ABSTRACT

A radio a frequency identification (RFID) system includes a RFID reader, and a RFID tag affixed to an asset, the asset surrounded in a wrapping having one or more conductive elements in proximity to the RFID tag to enable radio frequency (RF) signal distribution.

### BACKGROUND

The present invention relates to radio frequency identification (RFID), and more particularly to a wrapping with an antenna.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF label, which contains the RF circuitry and information to be transmitted. The antenna enables the integrated circuit to transmit its information to the reader that converts the radio waves reflected back from the RFID label into digital information that can then be passed on to computers that can analyze the data.

### SUMMARY

The present invention provides methods and apparatus for a wrapping with an antenna.

In general, in one aspect, the invention features a radio frequency identification (RFID) system including a RFID tag affixed to an asset, the asset surrounded by one or more conductive elements or wires in proximity to the RFID tag to enable radio frequency (RF) signal distribution.

In another aspect, the invention features a radio frequency identification (RFID) system including a RFID reader, and a RFID tag affixed to an asset, the asset surrounded in a wrapping having one or more conductive elements in proximity to the RFID tag to enable radio frequency (RF) signal distribution.

In another aspect, the invention features a system including an asset surrounded in a wrapping having one or more conductive elements to enable radio frequency (RF) signal distribution.

The invention can be implemented to realize one or more of the following advantages.

One or more conductive elements serve as an electrical antenna around a pallet of assets that re-radiates reader energy around the pallet to distribute the energy and improve readability.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary RFID system.

FIG. 2 is a block diagram of an exemplary RFID tag.

FIG. 3 is a block diagram of an exemplary RFID reader.

FIG. 4 is a block diagram of a wrapped asset.

Like reference numbers and designations in the various drawings indicate like elements.

### DETAILED DESCRIPTION

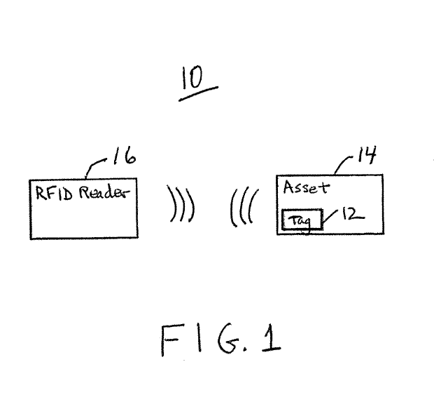

As shown in FIG. 1, an exemplary radio frequency identification (RFID) system 10 includes a RFID tag 12 (also referred to as a transponder) located on an asset 14 to be tracked. A RFID reader 16 (also referred to as an interrogator) sends a radio frequency (RF) signal (an interrogation) towards the RFID tag 12. The RF signal, also known as the carrier signal, initially supplies a voltage to an antenna coil of the RFID tag 12. The received voltage is rectified in the RFID tag 12 to supply power for the RFID tag 12. The RFID reader 16 modulates the carrier signal, using amplitude modulation (or AM modulation) to send data (such as a request for the RFID tag 12 to provide information such as the RFID tag's identification number) to the RFID tag 12. The RFID tag 12 responds by modulating the carrier signal and back scattering the modulated signal to the RFID reader 16.

Depending on the specific application, radio frequency identification (RFID) interrogators and antennas are configured differently to optimize RFID tag read rates. When writing to RFID tags, accuracy and time are key concerns.

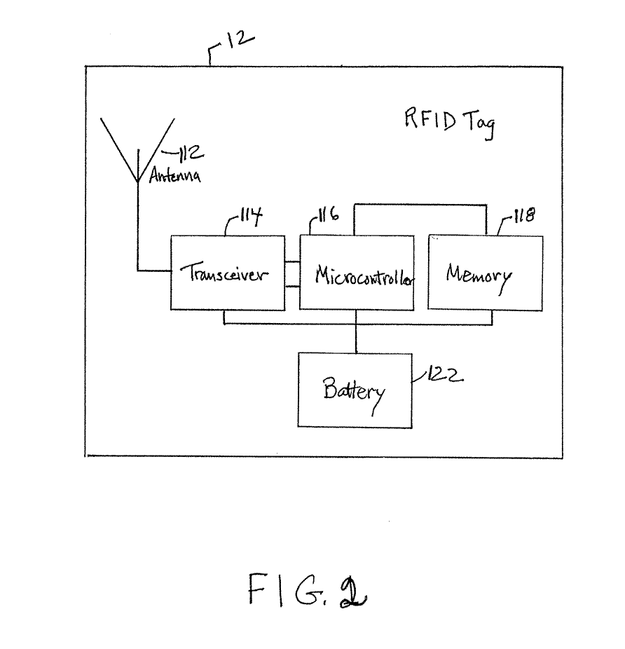

As shown in FIG. 2, the RFID tag 12 includes an antenna 112, transceiver 114, microcontroller 116, memory 118 and an optional battery 122. When triggered by RF interrogation via transceiver 114, microcontroller 116 fetches its data (e.g., time stamp, label identification and so forth) from memory 118 and sends it out to the RFID interrogator 16 as multiplexed data packets from transceiver 114.

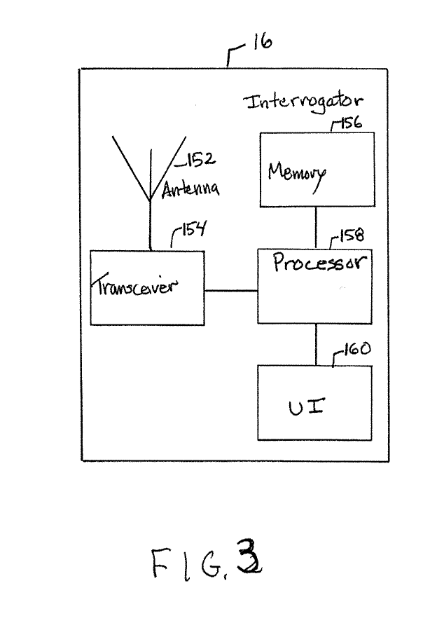

As shown in FIG. 3, the RFID interrogator 16 includes an antenna 152, transceiver 154, memory 156, processor 158 and optional user interface (UI) 160. The RFID interrogator 16 performs Time Division Multiplexing (TDM) with the transceiver 154 and antenna 152. Data downloaded from the RFID tag 12 can be stored in memory 156.

In general, the position of the RFID tag 12 with respect to the RFID interrogator 16 is key to preventing bad reads, i.e., situations in which the RFID tag 12 is not getting an RF signal from the RFID interrogator 16 or the RFID interrogator 16 is not getting an RF signal from the RFID tag 12. In inventory systems, the majority of bad reads are the result of the tag not getting the signal from the interrogator.

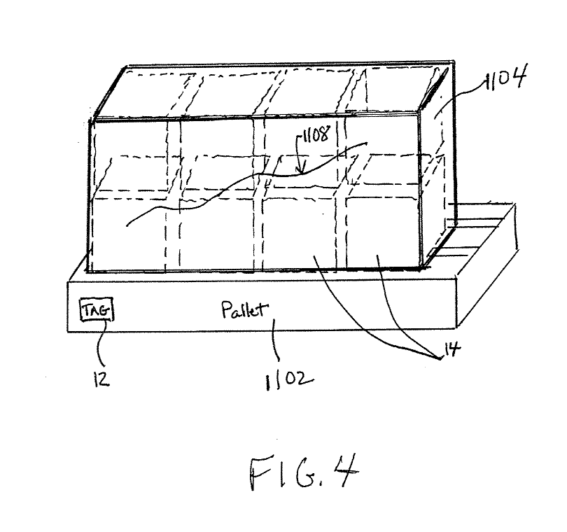

As shown in FIG. 4, the asset 14 is typically stacked on a pallet 1102 and surrounded by a wrapping 1104 that provides protection of the asset. In this example, RFID tag 12 is mounted on a portion of the pallet 1102. To help the RFID tag 12 receive an RF signal from the RFID interrogator 16 by distributing the interrogator's RF signal around the pallet 1102, the wrapping 1104 includes one or more embedded or affixed conductive elements or wires 1108. The conductive element 1108 facilitates RF signal distribution to prevent or limit bad reads. The conductive element 1108 serves as an electrical antenna around the pallet 1102 that re-radiates reader energy around the pallet 1102 to distribute the energy and improve readability. The wrapping 1104 can include shrink wrap plastic, paper, strapping, and so forth.

In other examples, the conductive element or elements 1108 is/are positioned around the pallet 1102 along with the wrapping 1104. The conductive elements 1108 may or may not be connected to each other. In still other examples, the conductive element or elements 1108 is/are connected to the RFID tag 12.

It is to be understood that the foregoing description is intended to illustrate and not to limit the scope of the invention, which is defined by the scope of the appended claims. Other embodiments are within the scope of the following claims.

What is claimed is:

1. A radio frequency identification (RFID) system comprising:
a RFID tag affixed to an asset, the asset surrounded in a wrapping having one or more conductive elements in proximity to the RFID tag to enable radio frequency (RF) signal distribution.

2. The RFID system of claim 1 wherein the RFID tag comprises:
an antenna linked to a transceiver; and
a microcontroller and a memory linked to the transceiver.

3. The RFID system of claim 1 further comprising a RFID reader.

4. The RFID system of claim 3 wherein the RFID reader sends a RF signal towards the RFID tag and the one or more conductive elements distribute the RF signal.

5. The RFID system of claim 3 wherein the RFID reader comprises:
an antenna linked to a transceiver; and
a memory and a processor linked to the transceiver.

6. The RFID system of claim 1 wherein the asset is a pallet of inventory.

7. The RFID system of claim 1 wherein the wrapping is shrink wrap plastic.

8. The RFID system of claim 1 wherein the wrapping is strapping.

9. The RFID system of claim 1 wherein the wrapping is paper.

10. A radio frequency identification (RFID) system comprising:
a RFID reader; and
a RFID tag affixed to an asset, the asset surrounded in a wrapping having one or more conductive elements in proximity to the RFID tag to enable radio frequency (RF) signal distribution.

11. The RFID system of claim 10 wherein the RFID reader comprises:
an antenna linked to a transceiver; and
a memory and a processor linked to the transceiver.

12. The RFID system of claim 10 wherein the RFID reader sends a RF signal towards the RFID tag and the one or more conductive elements distribute the RF signal.

13. The RFID system of claim 10 wherein the RFID tag comprises:
an antenna linked to a transceiver; and
a microcontroller and a memory linked to the transceiver.

14. The RFID system of claim 10 wherein the asset is a pallet of inventory.

15. The RFID system of claim 10 wherein the wrapping is shrink wrap plastic.

16. The RFID system of claim 10 wherein the wrapping is strapping.

17. The RFID system of claim 10 wherein the wrapping is paper.

18. A system comprising:
an asset surrounded in a wrapping having one or more conductive elements to enable radio frequency (RF) signal distribution.

19. The system of claim 18 further comprising a radio frequency identification (RFID) tag affixed to the asset proximate to the one or more conductive elements in the wrapping.

20. The system of claim 19 further comprising a RFID reader that sends a RF signal towards the RFID tag and the one or more conductive elements distribute the RF signal.
